(19) United States
(12) Patent Application Publication
(10) Pub. No.: US 2008/0251732 A1
(43) Pub. Date: Oct. 16, 2008

(54) Radiation Detector

(76) Inventors: Louis Dick, Geneva (CH); Rui De Oliveira, Arenthon (FR)

Correspondence Address: STURM & FIX LLP, 206 SIXTH AVENUE, SUITE 1213, DES MOINES, IA, 50309-4076, US

(21) Appl. No.: 10/597,571

(22) PCT Filed: Feb. 3, 2004
(86) PCT No.: PCT/IB2004/000276

§ 371 Date: Jul. 31, 2006

(51) Int. Cl. G01T 1/185

(52) U.S. Cl. 250/382

(57) ABSTRACT

The present invention provides a radiation detector in which primary electrons are released into a gas by ionizing radiation from a radiation source (10) and are caused to drift to read-out electrodes (1) by means of an electric field (2) generated by applying a negative tension to a drifting electrode (11) located near the radiation source (10), characterized in that it comprises three sets of longitudinal electrodes (1) forming three superposed planes which are substantially perpendicular to said electric field (2), the longitudinal electrodes (1) in the respective planes being applied progressively positive tensions relatively to the drifting electrode (11) when going from the plane (4) closest to the drifting electrode to the plane (4″) farthest from the drifting electrode, said plane (4″) farthest from the drifting electrode being applied a positive tension.

### BACKGROUND OF THE INVENTION

1. Field of the Invention

The present invention relates to a novel radiation detector that can be used for detecting in position ionizing radiations such as charged particles, photons, X-rays and neutrons. In the detector according to the invention, the primary electrons resulting from the ionization of the gas by radiation are multiplied under the effect of a high local intensity electric gradient field, and collected by the same structure.

2. Description of the Prior Art

Radiation detectors exploiting the process of ionization and charge multiplication in gases have been in use with continued improvements for many years. Methods for obtaining large “stable” proportional gains in gaseous detectors are a continuing subject of investigation in the detectors community.

Among the most widely known of such detectors is the parallel plate chamber (PPC). PPC has a counter obtained by means of two parallel grids spaced from one another by a few millimeters and between which the electrons are multiplied. This zone located between the two parallel grids is called the “multiplication zone”. Thus, the multiplication zone of such a detector is in the form of a single volume defined by the two grids. Due to the fact that it constitutes a single volume of a relatively large size, such a counter suffers from the disadvantage of being very breakdown sensitive. Moreover, the counters of such parallel plate detectors can only have a limited spatial resolution and due to the plate/grid thickness cannot be arranged in such a way as to form detectors having varied shapes. Finally, because the avalanche size depends exponentially on the distance of the primary ionization from the anode, PPC are not proportional counters.

Another type of gas detector is the multiwire proportional chamber (MWPC), which has a plurality of equidistant anode wires held taut in one plane. On either side of said plane are placed two taut grids forming cathodes. Electron multiplication takes place in the vicinity of the wires, because at this location there is a high electric field. However, the MWPC suffers from an intrinsic limitation: at high radiation rates, the production of slow positive ions results in the build-up of a space charge, which interferes with the counting and reduces gain. In addition, the physical characteristics of the MWPC does not permit the detector to have varied shapes.

A way to overcome on limitations of gain in parallel plate and multiwire proportional chambers (MWPC) is the multistep chamber, thereafter designated as MSC. In MSC chambers, two parallel grid electrode mounted in the drift region of a conventional gas detector and operated as parallel plate multipliers allow to preamplify drifting electrons and transfer them into the main detection element. Operated with a photosensitive gas mixture, the MSC chamber allows to reach gains large enough for single photodetection in ring-imaging CHERENKOV detectors, thereafter designated as RICH.

A more recent gas detector type is the microstrip gas chamber (MSGC). In the MSGC, the counter consists of coplanar electrodes etched on an insulating support. The major disadvantage of this detector is its relatively low gain limited essentially to 5,000, because it does not permit the superimposing of several counters. In addition, like the counters of parallel plate detectors described hereinbefore, the counters of these microstrip detectors have anisotropic multiplication zones localized on very thin tracks (approximately 10 micrometers), which makes them very sensitive to discharge damage. These detectors also suffer from the disadvantage of being relatively fragile and susceptible to aging.

Motivated by the problems mentioned above, a large effort has been devoted to find more rugged alternatives to MSGCs. Accordingly, a new class of detector called Micro-Pattern Detectors (MPD) developed.

F. BARTOL and al. Journal of Physics III 6 (1996), 337, introduced a new detector device (MPD) designated compteur à trous (CAT), which substantially consists of a matrix of holes which are drilled through a cathode metallic foil. The insertion of an insulating sheet between cathode and buried anodes allows to guarantee a good gap uniformity and to obtain high gains.

Another radiation detector device (MPD) was introduced at about the same time by Y. GIOMATARIS and al., Nucl. Instrum. And Meth. A376 (1996) 29. This detector thereafter designated as MICROMEGAS is a high gain gas detector using as multiplying element a narrow gap parallel plate avalanche chamber. In a general point of view, such a detector consists of a gap in the range 50 to 100 micrometer which is realized by stretching a thin metal micromesh electrode parallel to a read-out plane. Very high gain and rate capabilities have been attained due to the special properties of electrode avalanches in very high electric fields. A major inconvenience of this detector lies in the necessity of stretching and maintaining parallel meshes with great accuracy. The presence of strong electrostatic attraction forces adds to the problem, particularly for large size of the detectors. To overcome this drawback, heavy support frames are required and the introduction in the gap of closely spaced insulating lines or pins with the ensuing complication of assembly and loss of efficiency is necessary.

A further, still more recent gas detector type (MPD) is the gas electron multiplier (GEM). This detector consists of a set of holes, typically 50-100 micrometers, in diameter, chemically etched through a metal-kapton-metal thin foil composite, each of which produce a local electric field amplitude enhancement proper to generate in the gas an electron avalanche from each one of the primary electrons. The GEM acts as an “electrostatic lens”, and operates as an amplifier of given gain for the primary electrons. Charge detection is achieved by a separate readout electrode.

Exploiting the polyimide-etching technology developed for making GEM electrodes, other MPD detectors have been developed such as the microgroove (Bellazzini et al., Nucl. Instrum. And Meth. A424 (1998) 444) and the micro-wire (Adeva et al., Nucl. Instrum. And Meth. A435 (1999) 402) detectors.

However, all MPD devices exhibit a fast increasing discharge rate with voltage when exposed to high rates or highly ionizing alpha particles, hence a limitation in gain. In order to overcome this limitation, several devices (notably GEM devices) can be stacked for further gain, but to the expense of mechanical flexibility.

### SUMMARY OF THE INVENTION

The present invention is provides a radiation detector of very high performance that overcomes the above-mentioned drawbacks of the radiation detectors of the prior art.

The present invention provides a radiation detector that appears to hold both the simplicity of the MSGC chamber and the high field advantages of the MICROMEGAS, CAT and GEM radiation detectors, however mechanically much simpler to implement, less prone to discharge damage and more versatile in use.

More particularly, in accordance with the present invention, a radiation detector is provided in which primary electrons are released into a gas by ionizing radiations in a drift chamber and then drift to detection electrodes by means of an electric field. The radiation detector of the invention includes two or more superimposed planes of longitudinal electrodes, arranged in a non parallel geometry when viewed from above (e.g. each of three planes being at a 60 degree angle when compared to the others), so that they form a lattice. Each crossing of the two or more superimposed longitudinal electrodes provides an Intense electric field gradient which acts as a gas electron multiplier (avalanches) for the primary electron produced in the drift chamber. In addition, the two or more superimposed planes of longitudinal electrodes also act as a read out device collecting the charges created during the avalanche process. Accordingly, the lattice of longitudinal electrodes acts at the same time as an electron multiplier and as read out device, realizing a dual-purpose physical structure.

The resulting radiation detector allows to detect particles with great sensitivity, and determine their position with great accuracy. It can be used with great benefits in particle physics, but also in medical imaging, gas pressure gauges, materials inspections and many other industrial fields.

The objects, advantages and other particular features of the present invention will become more apparent upon reading of the following non-restrictive description of preferred embodiments thereof which are given by way of example only with reference to the accompanying drawings.

### BRIEF DESCRIPTION OF THE DRAWINGS

FIG. 1 is a schematic view of a radiation detector according to an embodiment of the present invention.

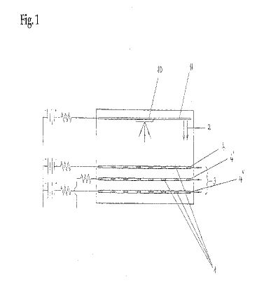

FIG. 2 is a schematic view from above of the dual-purpose physical structure according to invention.

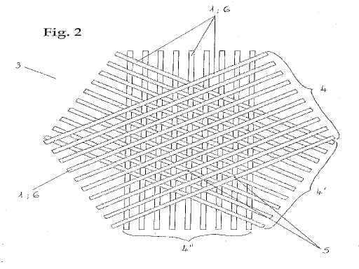

FIG. 3(a) is a schematic view from above of one of the planes formed by parallel conductive wires, according to an embodiment of the present invention.

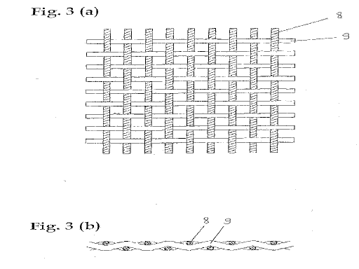

FIG. 3(b) is a schematic view from the side of one of the planes formed by parallel conductive wires, according to an embodiment of the present invention.

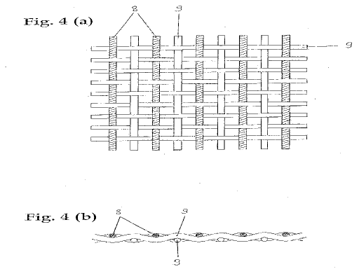

FIG. 4(a) is a schematic view from above of one of the planes formed by parallel conductive wires, according to another embodiment of the present invention.

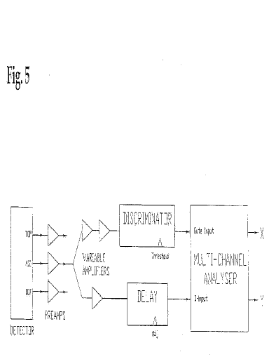

FIG. 4(b) is a schematic view from the side of one of the planes formed by parallel conductive wires, according to another embodiment of the present invention.

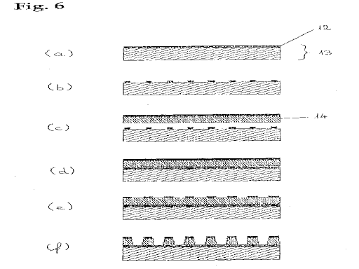

FIG. 5 is a flowchart of signal processing for a radiation detector according to the invention.

FIG. 6(a) to (l) is a step-by-step schematic for the fabrication of a 2-planes dual-purpose physical structure with glue spacers.

FIG. 7(a) to (i) is a step-by-step schematic for the fabrication of a 3-planes dual-purpose physical structure with polyimide spacers.

FIG. 8(a) to (e) are experimental spectra obtained using a three-planes radiation detector according to the invention using a Fe 55 radiation source.

### DESCRIPTION OF THE INVENTION

The present invention provides a radiation detector in which primary electrons are released into a gas by ionizing radiation from a radiation source (10), and are caused to drift to read-out electrodes (1) by means of an electric field (2) generated by applying a negative tension to a drifting electrode (11) located near the radiation source (10), said radiation detector comprising
a matrix of electric field condensing areas, each of said condensing areas producing a local electric field gradient sufficient to generate in said gas an electron avalanche from one of said primary electrons so that said gas electron multiplier operates as an amplifier for said primary electrons, and
a position-sensitive signal detector comprising read-out electrodes (1) to which is applied a tension which is positive relatively to the drifting electrode (11), characterized in that said matrix of electric field condensing areas and said signal detector are united in a same dual-purpose physical structure (3).

The gas used in the radiation detector can be any gas or combination of gas susceptible of being ionized and undergo avalanches, such as Helium, Argon, Xenon, Methane, Carbon dioxide, Argon/Carbon Dioxide combination, etc.

In a preferred embodiment of the invention, the dual-purpose physical structure (3) of the invention comprises
a first set of longitudinal electrodes (1) disposed parallel to each other to form a first plane (4), said first plane being substantially perpendicular to said electric field (2), and
at least one additional set of longitudinal electrodes (1) disposed parallel to each other to form at least one additional plane (4′), said additional plane or planes being superposed and parallel to said first plane (4),
   wherein the direction of the longitudinal electrodes (1) in each of said planes forms an angle with the direction of the longitudinal electrodes (1) in each of the other plane or planes, each crossing of said longitudinal electrodes in their respective planes producing a local electric field gradient, and
   wherein the longitudinal electrodes (1) in the respective planes are applied progressively positive tensions relatively to the drifting electrode (11) when going from the plane (4) closest to the drifting electrode to the plane farthest from the drifting electrode, said plane farthest from the drifting electrode being applied a positive tension. The electrodes in this plane are intended to collect the electrons.

The respective planes of longitudinal electrodes (1) are preferably, but without limitation, separated from each others by 40-60 micrometers.

In an embodiment of the present invention, the radiation detector is characterized in that said dual-purpose structure (3) comprises two sets of longitudinal electrodes (1) forming two superposed planes (4) and (4′), and in that, when viewed from above, the direction of the longitudinal electrodes (1) in the first plane (4) is perpendicular to the direction of the longitudinal electrodes (1) in the second plane (4′).

In another embodiment of the present invention, the radiation detector is characterized in that said dual-purpose structure (3) comprises three sets of longitudinal electrodes (1) forming three superposed planes (4), (4′) and (4″), in that the direction of the longitudinal electrodes (1) in each plane forms an angle of 60 degrees with the direction of the longitudinal electrodes (1) in each of the other planes, and in that, when viewed from above, the longitudinal electrodes (1) in a given plane cross the longitudinal electrodes (1) in the two other planes at the same points (5) where the longitudinal electrodes (1) in these two other planes cross. This feature ensures a strong electric field gradient at the level of the crossings, allowing electron avalanches. In comparison to the two-planes embodiment, the use of three planes allows to resolve positional ambiguities in multi-particle bursts.

Although angles of 90 degrees and 60 degrees are preferred for devices containing two, respectively three planes of longitudinal electrodes (1), any other angle may be used.

In an embodiment, the longitudinal electrodes forming the planes are conductive strips (6) (metallic or other conductive material).

These conductive strips can be spaced by spacers (7) located at the crossing points (5) of said conductive strips. Said spacers (7) may be made of glue, polyimide or any other suitable materials.

Mechanical resistance of the dual-purpose physical structure (3) is provided by epoxy, polyimide or any other suitable materials.

These embodiments are made through etching techniques as described in the “experimental procedures” section.

In another embodiment, the longitudinal electrodes disposed forming the planes are conductive wires (8) (metallic or other conductive material).

In a first sub-embodiment, said conductive wires (8) are woven with non-conductive wires (9) to form a mesh, said conductive wires (8) being oriented according to a first axis, and said non-conductive wires (9) being oriented according to a second axis, said second axis being perpendicular to the first axis.

In another sub-embodiment, said conductive wires (8) are individually alternated with non-conductive wires (9) in said first axis. This allows to obtain perfectly parallel and geometrically in-phase conductive wires despite their passing alternatively above and below the perpendicular non-conductive wires.

The sub-embodiments just described can be made by standard weaving techniques known to the person skilled in the art.

The conductive strips (6) or wires (8) can be made in any conductive materials, such as Tungsten of other metallic or non-metallic conductive materials.

The dual-purpose physical structure (3) according to the invention can be mechanically flexible, depending on the materials used and the size of the device. Accordingly, the dual-purpose physical structure (3) can take various shapes such as cylindrical, semi-spherical or other shapes.

The signal resulting from the individual longitudinal electrodes in each superposed planes is amplified, registered and properly treated in a multi-channel analyzer providing energy and location information for the particles detected by the detector.

### EXPERIMENTAL PROCEDURES

### Fabrication of a 2-Planes Dual-Purpose Physical Structure, Glue Spacers and Epoxy Support.

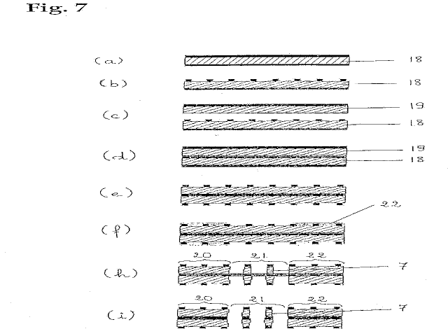

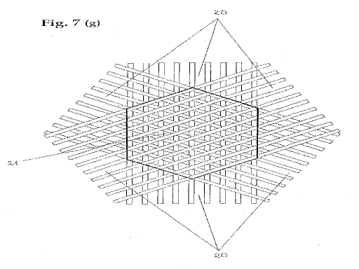

STEP 1: Begin with a base material of one-sided copper (12) epoxy board (13). FIG. 6(a).
STEP 2: The Image of the bottom pattern of strips is transferred onto the copper using standard process of photolithography. FIG. 6(b).
STEP 3: A piece of one-sided copper-clad polyimide (14) is prepared for gluing onto the bottom pattern. FIG. 6(c).
STEP 4: A piece of copper-plated polyimide is glued onto the bottom-patterned base piece. FIG. 6(d).
STEP 5: Tracks aligned directly above the bottom pattern, are etched into the copper-clad polyimide piece. FIG. 6(e).
STEP 6: The polyimide between the tracks is etched down to the level of the glue just above the bottom pattern. FIG. 6(f).
STEP 7: The tracks on the upper surface are then removed leaving only polyimide forms (15) that will support glue spacers. FIG. 6(g).
STEP 8: A sheet of copper foil (16) is prepared and glued onto the previous piece using enough glue to fill up all the space between the polyimide forms. FIG. 6(h).
STEPS 9: The top pattern is then transferred onto the copper foil using standard processes of photolithography (note that the top pattern is not visible in step 10 as the lines are running parallel with the view). FIG. 6(i).
STEP 10: A small amount of glue is etched away from above (from between the lines of the top pattern) in order to expose the polyimide forms. FIG. 6(j).
STEP 11: The polyimide forms are completely removed by etching, leaving glue spacers (7). FIG. 6(k).
STEP 12: To uncover the bottom pattern lines, a small amount of the glue is etched away. This leaves the top and bottom planes separated by empty space at the cross-over points with the top plane lines supported by the remaining glue spacers (7) in between. FIG. 6(l).
   Fabrication of a 3-Planes Dual-Purpose Physical structure, polyimide spacers and polyimide support.
STEP 1: Begin with a piece of double-sided copper-clad polyimide (18). FIG. 7(a).
STEP 2: The middle pattern is transferred onto one side of the two-sided copper-clad polyimide piece, using standard photolithography processes. FIG. 7(b).
STEP 3: A piece of one-sided copper-clad polyimide (19) is prepared by completely etching the copper from one side of a two-sided polyimide piece. FIG. 7(c).
STEP 4: The one-sided copper-clad polyimide piece (19) is then glued onto the top of the middle-patterned polyimide piece (18). FIG. 7(d).
STEP 5: The top and bottom patterns are transferred onto both sides of the piece using the standard photolithography processes. Care must be taken to ensure that the cross-over points of the strips on all three planes are precisely aligned. FIG. 7(e),
STEP 6: The peripheral areas (20) of the detector (on both sides), except in the area active for detection (21), are protected with a thin coating of polymer resin (22) that resists the polyimide etching solution. FIGS. 7(f) and 7(g).
STEP 7: The polyimide of the active area (21) is etched until the glue encapsulating the middle pattern is exposed, and the polymer resin (22) is removed. Polyimide spacers (7) under the copper patterns subsist FIG. 7(h).
STEP 8: The remaining glue in the active area (21) is removed. FIG. 7(i).
   Experimental Results with 3-Planes Metallic Strips and Polyimide Spacers, Dual-Purpose Physical Structure

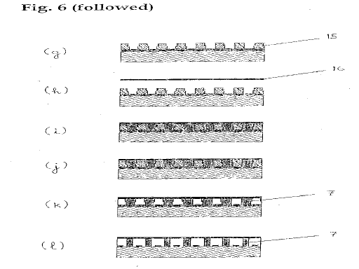

A 3-planes detector with metallic strips and polyimide spacers was successfully implemented according to the fabrication method above and shown to detect ionizing radiation from a Fe 55 radiation source. For the purpose of the experiment, the individual longitudinal electrodes in each plane were electrically connected. Therefore, the experiment demonstrates the detecting abilities of the detector without positioning function. It would be easy for a person skilled in the art to add the 2-dimensional positioning function by keeping the longitudinal electrodes isolated from each other, registering the signal for each electrode separately, and treating the resulting signal in an appropriate manner (see FIG. 5).

### Main Characteristics of the Detector:

Radiation source (at the top): Fe 55
distance of the radiation source to the top plane: 4 millimeters.
drifting electrode tension: −2000 V
top plane tension: −350 V
medium plane tension: 0 V
bottom plane tension: +350 v
gas: Argon 91%; Carbon dioxide 9%
gas pressure: atmospheric pressure
spacers: polyimide

### Signal Detection:

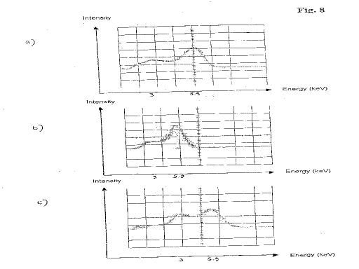

After proper amplification, the signal detected shows the typical spectrum for Fe 55, with peaks at 3 and 5.9 keV. FIG. 8(a) represents the spectrum detected by the plane (at +350V tension) farthest from the drifting electrode, which collects the electrons. FIG. 8(b) represent the spectrum detected by the middle plane (at ground). FIG. 8(c) represent the spectrum detected by the plane closest to the drifting electrode (at −350V tension). The middle plane and the plane closest to the drifting electrode both collect the positive ions.

1. A radiation detector in which primary electrons are released into a gas by ionizing radiation from a radiation source and are caused to drift to read-out electrodes by means of an electric field generated by applying a negative tension to a drifting electrode located near the radiation source, said radiation detector comprising:
a matrix of electric field condensing areas, each of said condensing areas producing a local electric field gradient sufficient to generate in said gas an electron avalanche from one of said primary electrons so that said gas electron multiplier operates as an amplifier for said primary electrons;
a position-sensitive signal detector comprising read-out electrodes to which is applied a tension which is positive relatively to the drifting electrode; and
wherein said matrix of electric field condensing areas and said signal detector are united in a same dual-purpose physical structure.

2. The radiation detector of claim 1, wherein said dual-purpose physical structure comprises:
a first set of longitudinal electrodes disposed parallel to each other to form a first plane closest to the radiation source, said first plane being substantially perpendicular to said electric field;
at least one additional set of longitudinal electrodes disposed parallel to each other to form at least one additional plane, said additional plane or planes being superposed and parallel to said first plane;
wherein the direction of the longitudinal electrodes in each of said planes forms an angle with the direction of the longitudinal electrodes in each of the other plane or planes, each crossing of said longitudinal electrodes in their respective planes producing a local electric field gradient; and
wherein the longitudinal electrodes in the respective planes are applied progressively positive tensions relatively to the drifting electrode when going from the plane closest to the drifting electrode to the plane farthest from the drifting electrode, said plane farthest from the drifting electrode being applied a positive tension.

3. The radiation detector of claim 2, wherein said dual-purpose structure comprises two sets of longitudinal electrodes forming two superposed planes and, when viewed from above, the direction of the longitudinal electrodes in the first plane is perpendicular to the direction of the longitudinal electrodes in the second plane.

4. The radiation detector of claim 2, wherein said dual-purpose structure comprises three sets of longitudinal electrodes forming three superposed planes, the direction of the longitudinal electrodes in each plane forms an angle of 60 degrees with the direction of the longitudinal electrodes in each of the other planes, and when viewed from above, the longitudinal electrodes in a given plane cross the longitudinal electrodes in the two other planes at the same points where the longitudinal electrodes in these two other planes cross.

5. The radiation detector of claim 2, wherein the longitudinal electrodes disposed parallel to each other forming said planes are conductive strips.

6. The radiation detector of claim 5, wherein said planes are spaced by spacers located at the crossing points of said conductive strips.

7. The radiation detector of claim 6, wherein said spacers are made of polyimide.

8. The radiation detector of claim 6, wherein said spacers are made of glue.

9. The radiation detector of claim 2, wherein the parallel longitudinal electrodes disposed parallel to each other forming said planes are conductive wires.

10. The radiation detector of claim 9, wherein said conductive wires are woven with non-conductive wires to form a mesh, said conductive wires being oriented according to a first axis and said non-conductive wires being oriented according to a second axis, said second axis being perpendicular to the first axis.

11. The radiation detector of claim 10, wherein said conductive wires are individually alternated with non-conductive wires in said first axis.

12. The radiation detector of claim 2, wherein the longitudinal electrodes in said dual-purpose structure are made of Tungsten.

13. The radiation detector of claim 1, wherein said dual-purpose physical structure is mechanically flexible.
